(19) United States
(12) Patent Application Publication
(10) Pub. No.: US 2015/0179165 A1
(43) Pub. Date: Jun. 25, 2015

(54) SYSTEM AND METHOD FOR CALLER INTENT LABELING OF THE CALL-CENTER CONVERSATIONS

(71) Applicant: Nuance Communications, Inc., Burlington, MA (US)

(72) Inventors: Shajith Ikbal Mohamed, Bangalore (IN); Prasanta Kumar Ghosh, New Delhi (IN); Ashish Verma, New Dehli (IN); Jeffrey N. Marcus, Newton, MA (US); Kenneth W. Church, Croton-on-Hudson, NY (US)

(73) Assignee: Nuance Communications, Inc., Burlington, MA (US)

(21) Appl. No.: 14/135,498

(22) Filed: Dec. 19, 2013

(51) Int. Cl. G10L 15/08; G06Q 30/00

(52) U.S. Cl. CPC G10L 15/08; G06Q 30/01

(57) ABSTRACT

Labeling a call, for instance by identifying an intent (i.e., the reason why the caller has called into the call center), of a caller in a conversation between a caller and an agent is a useful task for efficient customer relationship management (CRM). In an embodiment, a method of labeling sentences for presentation to a human can include selecting an intent bearing excerpt from sentences, presenting the intent bearing excerpt to the human, and enabling the human to apply a label to each sentence based on the presentation of the intent bearing excerpt. The method can reduce a manual labeling budget while increasing the accuracy of labeling models based on manual labeling.

### BACKGROUND OF THE INVENTION

Identifying an intent of a caller in a conversation between a caller and an agent of a call center is a useful task for efficient customer relationship management (CRM), where an intent may be, for example, a reason why the caller has called into the call center. CRM processes, both automatic and manual, can be designed to improve intent identification. Intent identification is useful for CRM to determine issues related to products and services, for example, in real-time as callers call the call center. In addition, these processes can both improve customer satisfaction and allow for crossselling/upselling of other products.

### SUMMARY OF THE INVENTION

In an embodiment, a method of labeling sentences for presentation to a human can include, in a hardware processor, selecting an intent bearing excerpt from sentences in a database, presenting the intent bearing excerpt to the human, and enabling the human to apply a label to each sentence based on the presentation of the intent bearing excerpt, the label being stored in a field of the database corresponding to the respective sentence. The sentences can be a grouping of sentences, such as from a same audio or text file. The sentences can be associated sentences or sentences associated with each other. The sentences can be related to each other by being from the same source (e.g., being from the same speaker or dialogue).

In another embodiment, the method can further include training the selecting of the intent bearing excerpt through use of manual input.

In yet another embodiment, the method can further include filtering the sentences used for training based on an intelligibility threshold. The intelligibility threshold can be an automatic speech recognition confidence threshold.

In yet another embodiment, the method can include choosing a representative sentence of a set of sentences based on at least one of similarity of the sentences of the set or similarity of intent bearing excerpts of the set of sentences. The method can further include applying the label to the entire set based on the label chosen for the intent bearing excerpt of the representative sentence.

In yet another embodiment, the intent bearing excerpt can be a non-contiguous portion of the sentences.

In another embodiment, the method can further include determining a part of the excerpt likely to include an intent of the sentences. Selecting the intent bearing excerpt can include focusing the selection on the part of the excerpt that includes the intent.

In yet another embodiment, the method can include loading the sentences by loading a record that includes a dialogue, monologue, transcription, dictation, or combination thereof.

In another embodiment, the method can include annotating the excerpt with a suggested label and presenting the excerpt with the suggested annotation to the human.

In another embodiment, the method can include presenting the intent bearing excerpt to a third party.

In another embodiment, a system for labeling sentences for presentation to a human can include a selection module configured to select an intent bearing excerpt from sentences with each other. The system can further include a presentation module configured to present the intent bearing excerpt to the human. The system can further include a labeling module configured to enable the human to apply a label to each of the sentence(s) based on the presentation of the intent bearing excerpt.

In another embodiment, a non-transitory computer-readable medium can be configured to store instructions for labeling sentences for presentation to a human. The instructions, when loaded and executed by a processor, can cause the processor to select an intent bearing excerpt from sentences, present the intent bearing excerpt to the human, and enable the human to apply a label to each sentence based on the presentation of the intent bearing excerpt.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating an example embodiment of a call preprocessing module employed in an example embodiment of the present invention.

FIG. 2 is a block diagram illustrating an example embodiment of a traditional labeling device.

FIG. 3 is a block diagram illustrating an example embodiment of a call preprocessing module.

FIG. 4 is a block diagram illustrating an example embodiment of the present invention including a labeling device, intelligibility classifier, intent summarizer, and active sampling module employed to represent a call preprocessing module.

FIG. 5 is a flow diagram illustrating an example embodiment of the present invention.

FIG. 6 illustrates a computer network or similar digital processing environment in which embodiments of the present invention may be implemented.

FIG. 7 is a diagram of an example internal structure of a computer (e.g., client processor/device 50 or server computers 60) in the computer system of FIG. 6.

### DETAILED DESCRIPTION OF THE INVENTION

A description of example embodiments of the invention follows.

In an embodiment of the present invention, call classification can have two phases. A first phase is the training of a classifier. In the first phase of training, a human is used to label example calls to train a classifier. Stated another way, training is can be a human assigning one of a set of labels to each call. Training produces a classifier, which is a form of a statistical model, which can be embodied as a file in a memory.

A second phase of call classification is the classification of calls not labeled during training. The second phase is performed by a computer program that extracts information from the calls and uses the classifier (e.g., statistical model) to attempt to automatically assign labels to the unlabeled calls. An embodiment of the present invention optimizes the first phase of training the classifier to minimize human labor in training the classifier and/or creating a more accurate classifier.

Manually labeling a subset of calls with intent labels helps accurately predict the intent labels for the remaining calls using a classifier trained by the manual labeling. While manually labeling most or all of the subsets of calls with intent labels can improve label prediction accuracy, such a large manual effort is costly and impractical in most scenarios.

A traditional call classification system assigns intent labels to all the unlabeled calls. Human supervised or semi-supervised methods achieve improved accuracy by manually assigning labels to calls. Human supervised or semi-supervised methods can include manual labeling of calls or providing labels to a classifier, which can then label calls. Prediction accuracy is high if more calls are manually labeled, but that requires a large manual effort. Based on a chosen budget of manual effort (e.g., labor budget, budget of manual labeling, budget of human effort, budget of human labeling), the system chooses a subset M of N total calls to label manually. The system trains a classifier based on the M manually labeled calls. The classifier is later used to automatically label the remaining N-M calls. Typically, higher accuracy can require a higher M value, or a higher M:N ratio.

In an embodiment, a labeling system is used to achieve an optimal label prediction accuracy with least possible manual effort. The labeling system includes three subsystems that reduce manual effort involved in traditional intent labeling systems. A first subsystem is a call intelligibility classifier. Not all the calls recorded by the call center are intelligible or contain useful information. For example, for some calls, the automated speech recognition (ASR) error rate is high enough that it is impossible to determine information, such as an intent, from the call. As another example, the caller can be speaking in a different language. As another example, the call may have produced an error at the interactive voice response (IVR) system and, therefore, not produced a useful text result. Discarding such unintelligible calls automatically reduces the manual effort involved in labeling such calls.

A second subsystem is a call intent summarizer. Caller intent is typically conveyed in short segments within calls. The call intent summarizer generates an intent-focused summary of the call to reduce the manual effort by a human by avoiding the reading by the human of the irrelevant parts of the calls. For example, consider a call stating “Hello. I am a customer and I would like to be able to check my account balance.” The call intent summarizer can generate a call intent summary stating “check my account balance,” saving the human the time of reading irrelevant words of the call.

A third subsystem is an active sampling module. Label information for one or more of the calls can be generalized to a set of calls. For example, the system may determine that a set of calls have a similar intent (e.g., by having a similar pattern of words, etc.). Upon a human's choosing an intent bearing label for one of the set of calls, a classifier can apply this label to the remainder of the calls, so there is no need for a human to label a call manually with the same intent again. Choosing an optimal set of calls for manual labeling can lead to maximal information gain and, thus, least manual effort because the human only has to label one representative call of the set as opposed to each call individually.

These three subsystems can be combined as a pre-screening process to use human effort to label calls manually more efficiently. The three systems combined reduce human effort from attempting to label calls manually that are unintelligible, prevents human effort from attempting to label calls manually similar to calls already manually labeled, and isolates intent bearing parts of the call so that the human can label each call faster. Combined, the three subsystems allow the manual labeling to apply to a broader set of calls and a more robust training of the classifier. Alternatively, less time can be spent manually labeling, thereby reducing the labor budget of a project, while still producing the same training of the classifier.

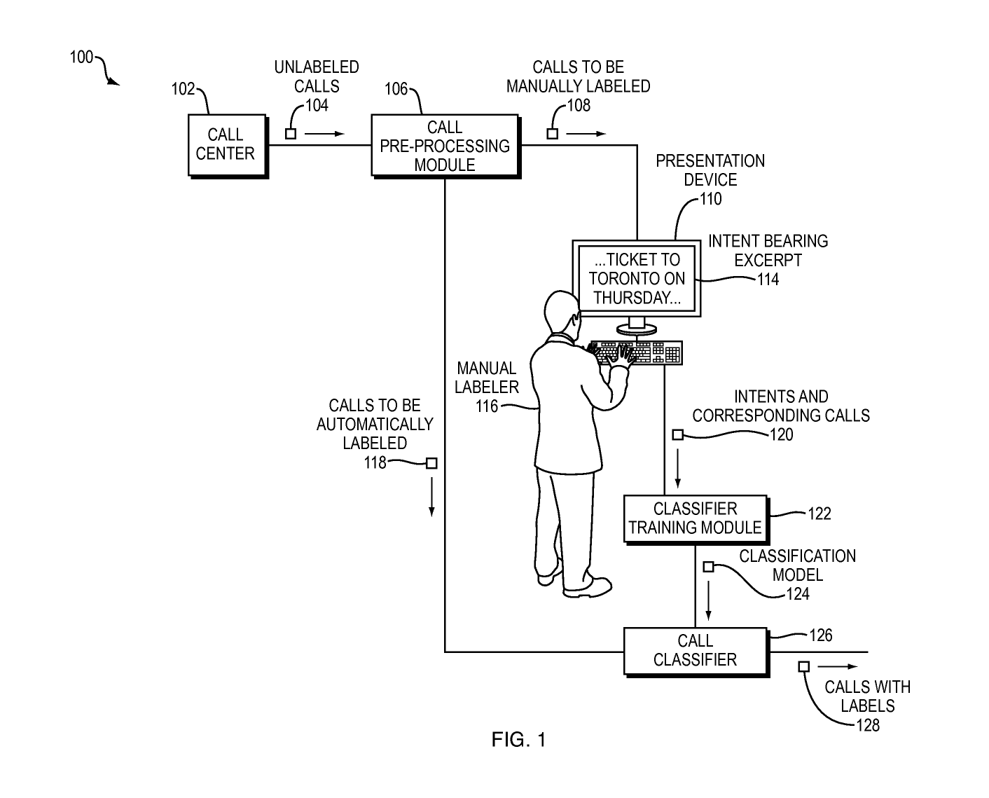

FIG. 1 is a block diagram 100 illustrating an example embodiment of a call preprocessing module 106 employed in an example embodiment of the present invention. A call center 102 can output records, such as unlabeled calls 104, to the call preprocessing module 106. The call preprocessing module 106, generally, filters the unlabeled calls 104 to enable more efficient manual labeling by a human. A company may have limited human resources to label the unlabeled calls 104, and therefore improving the efficiency of manual labeling effort is provided by embodiments of the present invention. Filtering the unlabeled calls 104 can improve the efficiency of manual labeling by preventing the human from performing repetitive, redundant, or wasteful work in manually labeling calls. This can allow the human to either label a same number of calls that creates a more accurate labeling model in the same length of time, and therefore, at the same cost to the company. It can also allow the human to label a smaller number of calls and create a labeling model with the same or improved accuracy in less human labeling time, and therefore, a lower cost to the company.

The call preprocessing module 106 outputs calls to be manually labeled 108 to a presentation device 110. A manual labeler 116, from the presentation device 110, reads an intent bearing excerpt 114 associated with one of the calls to be manually labeled 108. The call preprocessing module 106 generates the intent bearing excerpt 114 in processing the unlabeled calls 104. Consider an example unlabeled call 104 stating “Hello. I would like help to purchase a ticket to Toronto on Thursday.” An example intent bearing excerpt 114 for this call can be “ticket to Toronto on Thursday.” The manual labeler 116 can read the intent bearing excerpt 114 instead of reading the entire call, and therefore can label each call faster, because the presentation device 110 showing the manual labeler 116 only the intent bearing excerpt 114. The call preprocessing module 106, for example, can compute an intelligibility score for each call. Calls with a score below a threshold are assumed to be unintelligible and are filtered out of the list of calls to be manually labeled. The call preprocessing module 106 can further reduce the number of calls presented to the human by presenting for manual labeling only one call per group of similar calls. The call preprocessing module 106 can perform active sampling to group similar calls together, and only present one of a group of calls with similar intent bearing excerpts 114 to the manual labeler 116 on the presentation device 110.

Upon a budget of manual labor being exhausted, the presentation device 110 outputs intents and corresponding calls 120 to a classifier training module 122. The classifier training module 122 builds a classification model 124 based on the intents and corresponding calls 120. Then, a call classifier 126 receives calls to be automatically labeled 118 from the call preprocessing module 106. The call classifier 126, using the classification model 124, automatically labels the calls to be automatically labeled 118 and outputs calls with labels 128. Therefore, the call preprocessing module 106, by improving the efficiency of the manual labeler 116, either reduces the labor budget to be expended for manual labeling, or creates a more robust classification model 124 based on the improved efficiency of the manual labeler 116 with the same labor budget.

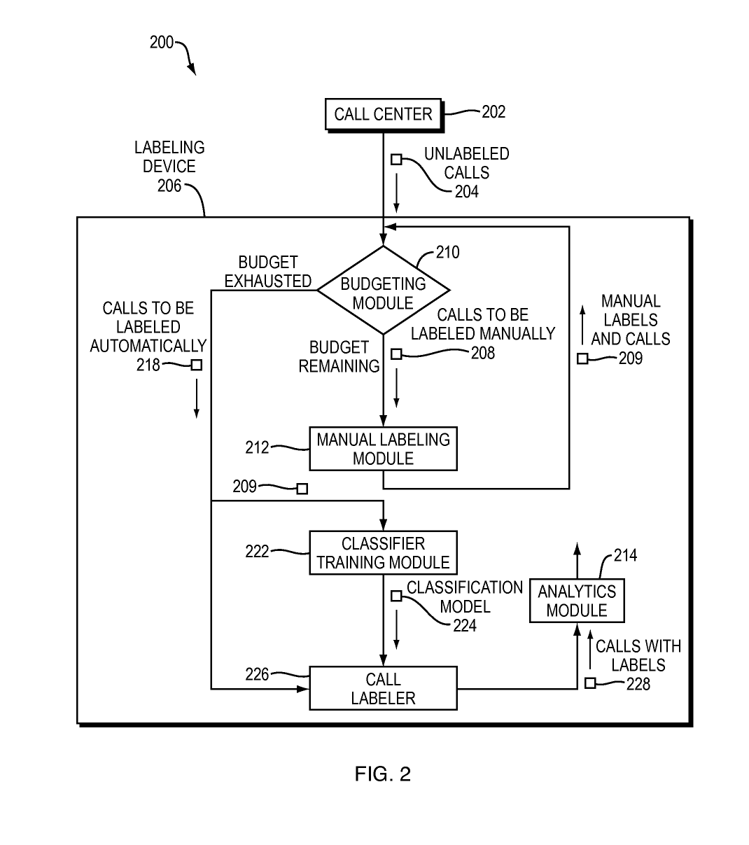

FIG. 2 is a block diagram 200 illustrating an example embodiment of a traditional labeling device 206. A call center 202 outputs unlabeled calls 204 to the labeling device 206. Upon receiving the unlabeled calls 204, the labeling device 206 determines, at a budgeting module 210, whether a budget of manual labeling has been exhausted. If a labor budget is remaining, the budgeting module 210 sends calls to be labeled manually 208 to a manual labeling module 212. Then, the labeling device 206 checks the budget of human labor again at the budgeting module 210. If the labor budget is exhausted, the budgeting module 210 forwards manual labels and calls 209 from the manual labeling module 212 to a classifier training module 222. The classifier training module 222 builds a corresponding classification model 224 based on the manual labels and calls 209. The classification model 224 is used by a call classifier to label calls 218 automatically that were not manually labeled, in addition to calls received in the future by the call center. The call classifier outputs calls with labels 228. Then, the system optionally analyzes and displays statistics on the distribution of call labels using an analytics module 214.

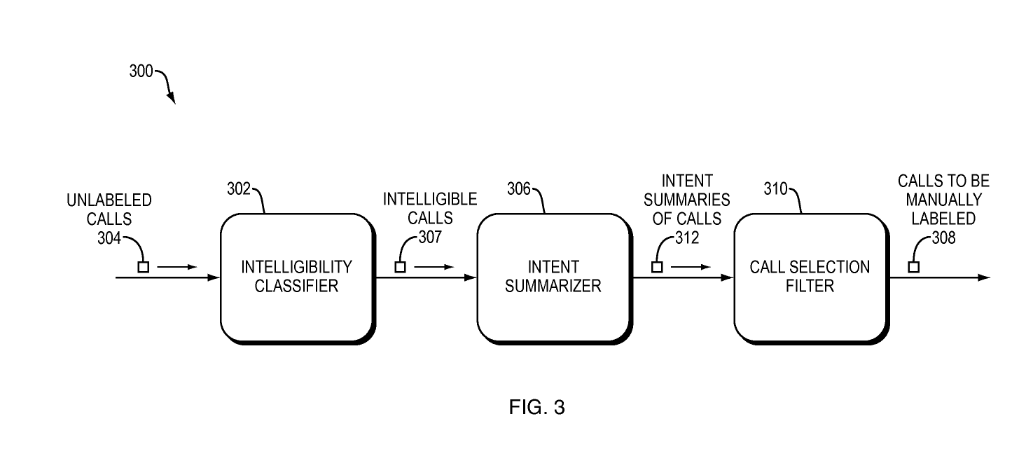

FIG. 3 is a block diagram 300 illustrating an example embodiment of a call preprocessing module. First, an intelligibility classifier 302 can receive unlabeled calls 304. The intelligibility classifier 302 filters the unlabeled calls 304 and outputs intelligible calls 307. The intelligible calls 307 are forwarded to an intent summarizer 306, with which outputs intent summaries 312 of the calls. The intent summaries 312 of calls are excerpts of the sentences of the intelligible calls 307 that are likely to include the intents of the calls 307. The human manual labeler then reads the intent summaries 312 to determine the intent from the summaries. Then, a call selection filter 310 reduces the number of calls for the human manual labeler to read by forming groups of calls that are determined to have the same meaning, and selecting a representative subset from each group for labeling, which is referred to as active sampling. The manual effort for labeling is reduced further by using an intent summarizer 306 to select intent-bearing excerpts of the call for presentation to the human labeler instead of presenting the entire call. Active sampling groups calls together that are in some way related to each other so that a manual labeler only reads intent summaries of one similar call instead of labeling the intent of an entire group that has similar intent bearing excerpts. A person of ordinary skill in the art can further recognize that the intent summarizer and call selection filter 310 can be run in parallel or in reverse order in different embodiments of the call preprocessing module.

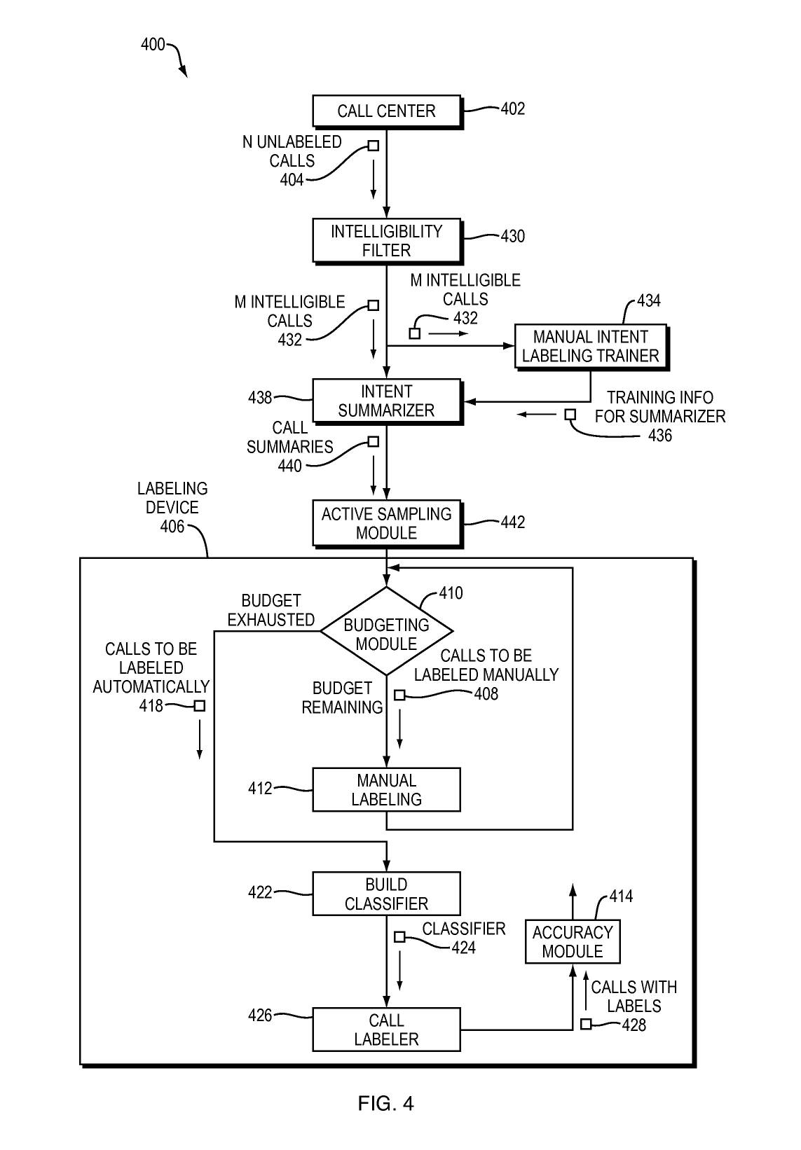

FIG. 4 is a block diagram 400 illustrating an example embodiment of the present invention including a labeling device 406, intelligibility classifier 430, intent summarizer 438, and active sampling module 442 employed to represent a call preprocessing module. A call center 402 outputs unlabeled calls 404 to the intelligibility filter 430. The intelligibility filter 430 scores each of the unlabeled calls 404 and outputs M intelligible calls 432. The M intelligible calls 432 are calls scored above a certain threshold of intelligibility.

The M intelligible calls 432 are then sent to a manual intent labeling trainer 434. The manual intent labeling trainer 434 is employed to train an intent summarizer 438 to find intent bearing excerpts of sentences. The intent summarizer 438 is not employed to find the intents themselves, but rather is employed to find areas of sentences in a call that are likely to have the intent. In order to perform such a summary of sentences, a user manually provides data on a number of calls to build a classifier, or training info for summarizer 436, that the intent summarizer 438 can use for the rest of the M intelligible calls 432. The intent summarizer 438 then outputs call summaries 440 to an active sampling module 442. The active sampling module 442 forms groups of calls that are determined to have the same meaning, and selects a representative subset from each group for labeling. The active sampling module 442 then only presents or displays a representative subset of calls or call summaries of each group to the user in manually labeling the calls. The representative subset of calls or call summaries can be one or more call or call summaries.

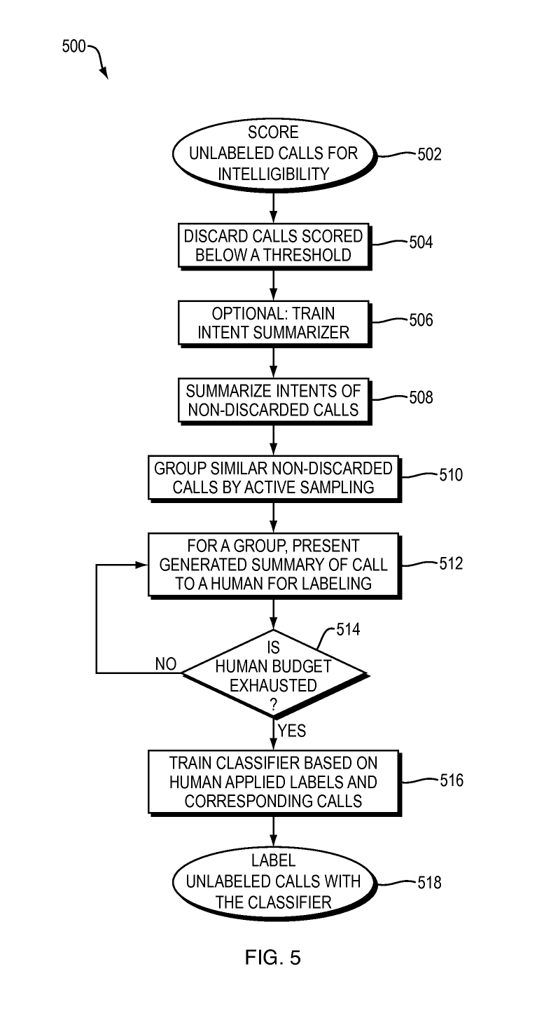

FIG. 5 is a block diagram 500 illustrating an example embodiment of the present invention. First, the process scores unlabeled calls for intelligibility (502). Then, the process discards calls scored below a threshold (504). The process then optionally trains an intent summarizer (506). The process trains the intent summarizer upon a first use of the process for a given context; however, once the intent summarizer is trained, subsequent uses may not require training. Then, the process summarizes intents of the non-discarded calls (508). The system then groups similar non-discarded calls by active sampling (510). Then, for a group, the process presents the generated summary of a call to human for labeling. After the human labels the call, the system determines whether the labor budget is exhausted (514). If not, the system presents another call representative of a group by presenting the generated summary of the call to the human for labeling (512). Otherwise, if the labor budget is exhausted (514), the system trains a classifier based on all of the human applied labels and corresponding calls (516). Then, the system labels remaining unlabeled calls with the classifier (518).

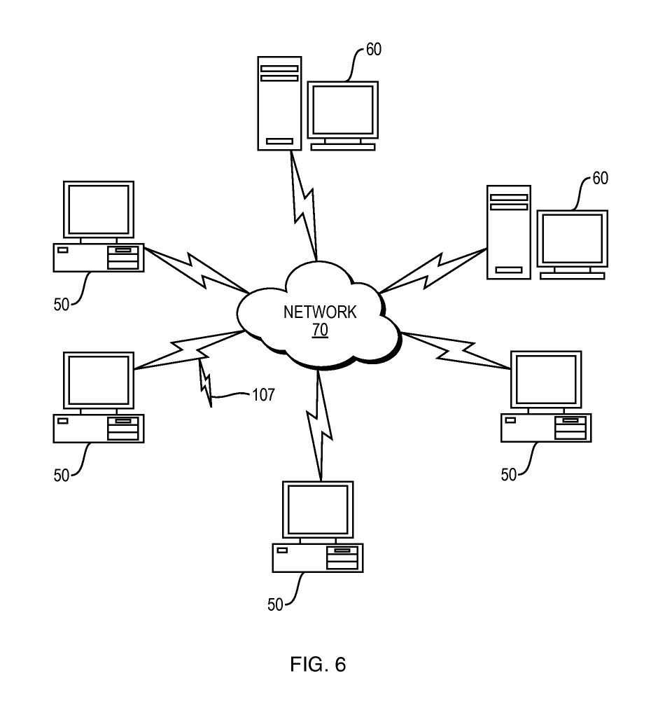

FIG. 6 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

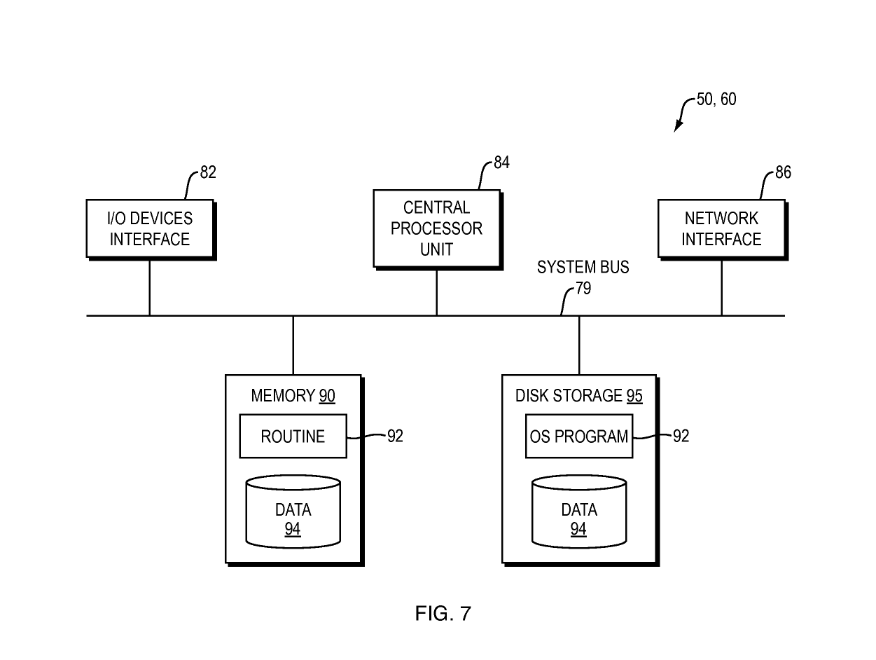

FIG. 7 is a diagram of an example internal structure of a computer (e.g., client processor/device 50 or server computers 60) in the computer system of FIG. 6. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 6). Memory 90 provides volatile storage for computer software instructions 92 and data 94 used to implement an embodiment of the present invention (e.g., selection module, presentation module and labeling module code detailed above). Disk storage 95 provides non-volatile storage for computer software instructions 92 and data 94 used to implement an embodiment of the present invention. A central processor unit 84 is also attached to the system bus 79 and provides for the execution of computer instructions. The disk storage 95 or memory 90 can provide storage for a database. Embodiments of a database can include a SQL database, text file, or other organized collection of data.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

While this invention has been particularly shown and described with references to example embodiments thereof, it will be understood by those skilled in the art that various changes in form and details may be made therein without departing from the scope of the invention encompassed by the appended claims.

What is claimed is:

1. A method of labeling sentences for presentation to a human, the method comprising:
in a processor:
selecting an intent bearing excerpt from sentences stored in a database;
presenting the intent bearing excerpt to the human; and
enabling the human to apply a label to each sentence based on the presentation of the intent bearing excerpt, the label being stored in a field of the database corresponding to the respective sentence.

2. The method of claim 1, further comprising training the selecting of the intent bearing excerpt through use of manual input.

3. The method of claim 2, further comprising filtering the sentences used for training based on an intelligibility threshold.

4. The method of claim 3, wherein the intelligibility threshold is an automatic speech recognition confidence threshold.

5. The method of claim 1, further comprising:
choosing a representative sentence of a set of sentences based on at least one of similarity of the sentences of the set or similarity of intent bearing excerpts of the set of sentences; and
applying the label to the entire set based on the label chosen for the intent bearing excerpt of the representative sentence.

6. The method of claim 1, wherein the intent bearing excerpt is a non-contiguous portion of the sentences.

7. The method of claim 1, further comprising determining a part of the excerpt likely to include an intent of the sentences; and
wherein selecting the intent bearing excerpt includes focusing the selection on the part of the excerpt that includes the intent.

8. The method of claim 1, further comprising loading the sentences by loading a record that includes a dialogue, monologue, transcription, dictation, or combination thereof.

9. The method of claim 1, further comprising annotating the excerpt with a suggested label and presenting the excerpt with the suggested annotation to the human.

10. The method of claim 1, further comprising presenting the intent bearing excerpt to a third party.

11. A system for labeling sentences for presentation to a human, the system comprising:
a selection module configured to select an intent bearing excerpt from sentences stored in a database;
a presentation module configured to present the intent bearing excerpt to the human; and
a labeling module configured to enable the human to apply a label to each sentence based on the presentation of the intent bearing excerpt, the label being stored in a field of the database corresponding to the respective sentence.

12. The system of claim 11, further comprising a training module configured to train the selection module through use of manual input.

13. The system of claim 12, further comprising a filtering module configured to filter the sentences used for training based on an intelligibility threshold.

14. The system of claim 13, wherein the filtering module is configured to employ the intelligibility threshold as an automatic speech recognition confidence threshold.

15. The system of claim 11, further comprising a sampling module configured to choose a representative sentence of a set of sentences based on at least one of similarity of the sentences of the set or similarity of intent bearing excerpts of the set of sentences, and apply the label to the entire set based on the label chosen for the intent bearing excerpt of the representative sentence.

16. The system of claim 11, wherein the selection module is further configured to determine a part of the excerpt likely to include an intent of the sentences and select the intent bearing excerpt by focusing the selection on the part of the excerpt that includes the intent.

17. The system of claim 11, wherein the selection module is further configured to load the sentences by loading a record that includes a dialogue, monologue, transcription, dictation, or combination thereof.

18. The system of claim 11, wherein the labeling module is further configured to annotate the excerpt with a suggested label and presenting the excerpt with the suggested annotation to the human.

19. The system of claim 11, further comprising presenting the intent bearing excerpt to a third party.

20. A non-transitory computer-readable medium configured to store instructions for labeling sentences for presentation to a human, the instructions, when loaded and executed by a processor, causes the processor to:
select an intent bearing excerpt from sentences in a database;
present the intent bearing excerpt to the human; and
enable the human to apply a label to each sentence based on the presentation of the intent bearing excerpt, the label being stored in a field of the database corresponding to the respective sentence.
